(19) United States
(12) Patent Application Publication
(10) Pub. No.: US 2026/0126099 A1
(43) Pub. Date: May 7, 2026

(54) MECHANICAL SPEED REDUCING ASSEMBLY

(71) Applicant: INNOVATIVE MECHATRONIC SYSTEMS B.V., Rijswijk (NL)

(72) Inventors: Jack SCHORSCH, Rijswijk (NL); Alfons SCHURE, Rijswijk (NL); Job NEVEN, Rijswijk (NL)

(21) Appl. No.: 19/116,244

(22) PCT Filed: Sep. 28, 2023
(86) PCT No.: PCT/EP2023/076972

§ 371 Date: Mar. 27, 2025

(30) Foreign Application Priority Data
Sep. 28, 2022 (EP) 22198508.8

(51) Int. Cl. F16H 15/56; F16H 57/02

(52) U.S. Cl. CPC F16H 15/56; F16H 57/02004

(57) ABSTRACT

Mechanical speed reducing assembly comprising a first sun wheel, a first ring wheel arranged concentrically about the first sun wheel, such that the first sun wheel and the first ring wheel share a first symmetry axis, a hollow first planetary member comprising a first cylindrical section in frictional engagement with an outer surface of the first sun wheel and with an inner surface of the first ring wheel, the first planetary member being arranged to rotate about a second axis, wherein the first planetary member comprises a circumferential first groove and a circumferential second groove, which are spaced apart from each other by the first cylindrical section, and a first alignment ring which is secured to the first sun wheel or to the first ring wheel against motion along the first symmetry axis and which protrudes into the first groove or the second groove.

The present invention relates to a mechanical speed reducing assembly comprising several rotationally symmetric members and to a method of assembling the mechanical speed reducing assembly. Depending on which of the member(s) receives an input torque, the suggested mechanical speed reducing assembly is suitable for altering the magnitude or direction of the output rotational speed, with respect to the input rotational speed.

WO 2018/178380 A1 discloses a compound planetary friction drive comprising a first sun wheel and planetary wheels, wherein said first sun wheel engages said planetary wheels, which planetary wheels are arranged with two outer parts having a first radius and a central part having a second radius, wherein the second radius differs from the first radius and transition regions are provided between the outer parts and the central part, and wherein an outer ring annulus and a central ring annulus are provided that are in driving engagement with the planetary wheels, wherein the outer ring annulus has two parts between which, along the length of the planetary wheels, the central ring annulus is disposed, wherein the first sun wheel is in frictional engagement with the outer parts of the planetary wheels, said outer parts of the planetary wheels are in frictional engagement with the parts of the outer ring annulus and the central ring annulus is in frictional engagement with the central part of the planetary wheels, wherein the planetary wheels are both hollow and compressible uninterruptedly along their entire length spanning the outer parts, the transition regions and the central part.

### Problem and Solution

A problem to be solved can be seen in providing an improved mechanical speed reducing assembly.

This problem is solved by the mechanical speed reducing assembly according to claim 1 and by the preferred embodiments also according to the dependent claims.

The mechanical speed reducing assembly according to the invention (first aspect) comprises a first sun wheel and a first ring wheel. The first ring wheel is arranged concentrically about the first sun wheel, such that the first sun wheel and the first ring wheel share a first symmetry axis. The assembly further comprises at least one hollow first planetary member having a first cylindrical section in frictional engagement with an outer surface of the first sun wheel and with an inner surface of the first ring wheel. The first cylindrical section serves as a running surface of the first planetary member. The first planetary member is arranged to rotate about a second axis and comprises a circumferential first groove and a circumferential second groove, which are spaced apart from each other by the first cylindrical section. The assembly further comprises at least a first alignment ring which is secured to the first sun wheel or to the first ring wheel against moving along the first symmetry axis and which protrudes into the first groove or the second groove.

The alignment ring which is secured against moving along the first symmetry axis may act against undesired motion of the first planetary member along the first or second axis, as the alignment ring also protrudes into the first groove or the second groove. This may help to reduce slipping and/or abrasion particularly caused by relative rotation of the first planetary member while the assembly is operational.

In the prior art, planetary members are often constrained by means of an axle & cam system to achieve alignment of the planetary members with the sun wheel and ring wheel. In the prior art, an alignment feature may serve to align an output member of the assembly with the rotational axis of the planetary members.

The first planetary member of the present invention may move and rotate with respect to more than one axis. The second axis of the planetary member is not fixed with respect to the first symmetry axis. An output member of the assembly can be fixed by an external bearing. The alignment ring may urge the second axis to align more with the first symmetry axis. The first alignment ring may provide a thrust bearing surface for imposing thrust on the first planetary member to urge the second axis to align more with the first symmetry axis.

Further, for any given amount of compression force applied to a contact surface, a fixed amount of traction ‘thrust’ is available, as determined by the coefficient of friction. If any degree of skewness occurs, the ‘angle’ along which that traction thrust is vectored and becomes non-parallel with the desired line of motion. Any component of the vector which is not parallel with the allowed line of action becomes lost. If the assembly is constrained against axial motion, the components must slip in the axial direction. The coefficient of friction when in slip is lower than when in traction, causing additional losses. An angle of skew may occur which causes the assembly to lose tractive effort rapidly. Changing the profile & location of the first alignment ring may act against this critical skew angle. By reducing the amount of lost thrust, torque capacity & efficiency of the assembly are increased. By reducing the amount of slippage, abrasive wear of the members of the assembly can be smaller and service life of the assembly may be extended.

### Preferred Embodiments

Preferred embodiments which are explained in the following and by the dependent claims may be combined advantageously unless indicated otherwise.

The assembly may be a single stage planetary speed reducing assembly. The at least one first planetary member may be supported by a planetary carrier. The assembly can be part of a superordinate multi-stage planetary speed reducing assembly.

The first alignment ring of an embodiment comprises an alignment shoulder, which is arranged to engage with a groove side face of the first groove or of the second groove, which groove side face is generally perpendicular to the second axis. The alignment shoulder serves for inducing a stabilizing moment on to the planetary member with a direction and magnitude urging second axis to align more with the first symmetry axis. The alignment shoulder can be a mechanical flange or shoulder. The radial profile of the alignment shoulder is preferably straight, convex, concave, or of complex geometry, so as to satisfy the demand for stability implied by the location of the shoulder and the nominal dimensions of the constituent components. The alignment shoulder may extend from a side face of the first alignment ring, which side face is perpendicular to the first or second axis. The alignment shoulder

In an embodiment, the first groove and/or the second groove comprises a mating shoulder arranged to engage with the alignment shoulder. The mating shoulder may be shaped to complement the alignment shoulder. Greater or lesser angles of contact can be used, to produce greater or lesser stabilizing forces. The profile of the mating shoulder may be exactly like the profile of the alignment shoulder, or be transformed to allow for manufacturability. The radial profile of the mating shoulder is preferably straight, convex, concave, or of complex geometry, so as to satisfy the demand for stability implied by the location of the shoulder and the nominal dimensions of the constituent components.

In another embodiment the first ring wheel comprises a first recess extending circumferentially about the first symmetry axis, which first recess is arranged to accept the first alignment ring partially. Preferably the first ring wheel comprises a second recess extending circumferentially about the first symmetry axis and spaced apart from the first recess along the first symmetry axis, which second recess is arranged to accept the first alignment ring partially. The first alignment ring may help fixed in the recess against rotation relative to the first ring wheel.

The first sun wheel of a further embodiment comprises a first recess extending circumferentially about the first symmetry axis, which first recess is arranged to accept the first alignment ring partially. Preferably, the first sun wheel comprises a second recess extending circumferentially about the first symmetry axis and spaced apart from the first recess along the first symmetry axis, which second recess is arranged to accept the first alignment ring partially. The first alignment ring may help fixed in the recess against rotation relative to the first sun wheel.

An embodiment comprises a second alignment ring similar to the first alignment ring, which second alignment ring is to be arranged partially in the second recess. Preferably, the first alignment ring engages with the first groove and/or the second alignment ring engages with the second groove.

According to another embodiment, the first alignment ring, the first recess and/or the second recess comprises a curved crown. The curved crown may be limited by a portion of a circle preferably having a radius within the range of 0.025 mm to 25.4 mm, or a portion of an ellipse, or portion of a logarithmic curve. A curved crown of the first alignment ring may extend towards a circumferential surface of the first or second recess or towards a groove side face of the first groove or of the second groove. Alternatively or additionally, a curved crown of the first or second groove can protrude towards a circumferential face of the first alignment ring or from one of the groove side faces to engage with a side face of the first alignment ring. The curved crown may extend circumferentially about the first symmetry axis or about the second axis. The curved crown may help to protect a circumferential edge of the first alignment ring, the first recess and/or the second recess against abrasion.

An embodiment comprises at least a hollow second planetary member and a hollow third planetary member similar to the first planetary member. These planetary members are arranged about the first symmetry axis, each of which planetary members is in frictional engagement with the outer surface of the first sun wheel and with the inner surface of the first ring wheel. Particularly, the fourth and further planetary members similar to the first planetary member may help to reduce the torque to be transferred by each of these planetary members. This embodiment may serve as a single stage speed reducing assembly. Depending on which member(s) of the assembly receives an input torque, the suggested mechanical speed reducing assembly is suitable for increasing the input rotational speed.

In a preferred embodiment, at least the first planetary member comprises a second cylindrical section similar to the first cylindrical section, wherein the first or second groove is arranged between the second cylindrical section and the first cylindrical section. At least the first planetary member may comprise a third cylindrical section similar to the first cylindrical section, wherein the first, the second and the third cylindrical section are separated from each other by the first and second groove. The first planetary member may have been machined from a single blank. Alternatively, two of the cylindrical sections have been machined separately prior to being joined. One or more of the grooves may have been machined into the first planetary member by a lathing step.

Another embodiment further comprises a second sun wheel and a second ring wheel arranged concentrically about the second sun wheel, wherein the second sun wheel and the second ring wheel share the first symmetry axis. The second cylindrical section is in frictional engagement with an outer surface of the second sun wheel and with an inner surface of the second ring wheel. Depending on which member of the assembly receives an input torque, the suggested mechanical speed reducing assembly is suitable for increasing the input rotational speed. One of the sun wheels, preferably the second sun wheel may be fixed rotationally during operation of the embodiment.

An embodiment further comprises a bearing arranged about the first axis of symmetry, wherein the bearing engages with a sun wheel side face of the first sun wheel and with a sun wheel side face of the second sun wheel, which sun wheel side faces are perpendicular to the first symmetry axis. The bearing may help to reduce the wear of the sun wheels. The bearing may help to stabilise the first sun wheel during operation of the embodiment. The bearing can be a roller bearing or a needle bearing.

A further embodiment further comprises a third ring wheel, wherein the first ring wheel is arranged between the second ring wheel and the third ring wheel, wherein at least the first planetary member, particular a third cylindrical section, is in frictional engagement with an inner surface of the third ring wheel. The embodiment may comprise a third sun wheel, an outer surface of which is in frictional engagement at least with the first planetary member, particular with its third cylindrical section, wherein the first sun wheel is arranged between the second and third sun wheel. There may be a further bearing between the third sun wheel and the first sun wheel, allowing the first sun wheel to rotate relative to the third sun wheel. The planetary member(s) of this embodiment may comprise a third cylindrical section, the second groove, the first cylindrical section, the first groove and a second cylindrical section. One or more of the groove side faces may comprise mating shoulder(s). This embodiment may serve as a two stage planetary speed reducing assembly.

Preferably, the second and third ring wheel are coupled rotationally. The coupled ring wheels may serve as the torque output member of the embodiment.

A method of manufacturing (second aspect) a mechanical speed reducing assembly as described before preferably comprises the steps
S1 inserting one of the alignment rings into one of the recesses of the first sun wheel or of the first ring wheel,
S2 inserting the alignment ring into the first or second groove at least of the first planetary member,
S3 arranging the first sun wheel relative to the first ring wheel such that these are arranged concentrically and share the first symmetry axis.

### Exemplary Embodiments

Further details and advantages of the invention become apparent to the skilled person from the exemplary embodiment described in the following.

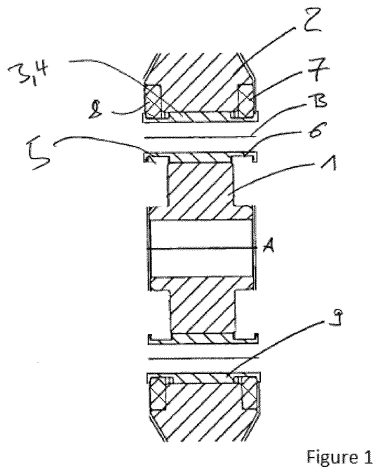

FIG. 1 shows a cross section of an exemplary embodiment of a mechanical speed reducing assembly (on the left). The assembly comprises a first sun wheel 1, a first ring wheel 2 arranged concentrically about the first sun wheel, such that the first sun wheel and the first ring wheel share a first symmetry axis A, at least a hollow first planetary member 3 comprising a first cylindrical section 4, which first cylindrical section is in frictional engagement with an outer surface of the first sun wheel and with an inner surface of the first ring wheel, the first planetary member being arranged to rotate about a second axis B. The first planetary member comprises a circumferential first groove 5 and a circumferential second groove 6, which are spaced apart from each other by the first cylindrical section. The assembly further comprises at least a first alignment ring 7 which is secured to the first ring wheel against motion along the first symmetry axis and which protrudes into the first groove. While only two planetary members 3, 9 are shown, the embodiment comprises at least a third and a fourth planetary member (not shown) which are of similar structure. In addition, the embodiment comprises a second alignment ring 8 which is also secured to the first ring wheel against motion along the first symmetry axis and which protrudes into the second groove. Each of the alignment rings is held partially in a respective recess of the first ring wheel which recesses 10 are shown on the right of FIG. 1

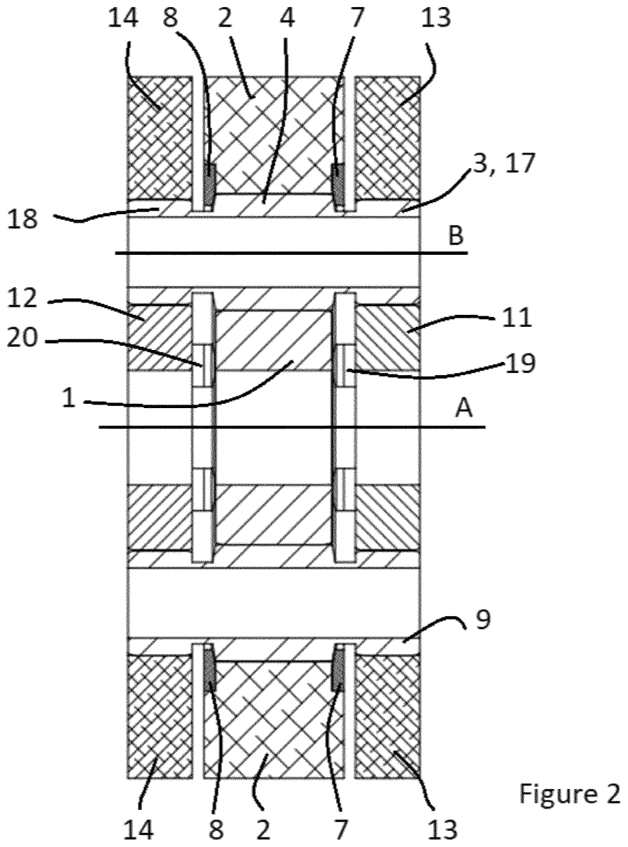

FIG. 2 shows a cross section of another exemplary embodiment. Further to the members shown in FIG. 1, the embodiment additionally comprises a second 11 and third sun wheel 12, a second 13 and third ring wheel 14, at least a second planetary member 15 and a second alignment ring 16 similar to the first alignment ring. The first 7 and second alignment rings 8 are secured to the first ring wheel against moving along the first symmetry axis and engage with the first and second grooves of the respective planetary member. Each of the alignment rings is held partially in a respective recess of the first ring wheel 2. The planetary members each comprise a second 17 and a third cylindrical section 18. Each of the first and second grooves is arranged between two of the cylindrical sections, as is shown. Despite its grooves, each of the planetary members is of a single piece hollow structure.

The first cylindrical section 4 engages frictionally with the outer surface of the first sun wheel 1 and with the inner surface of the first ring wheel 2. The second cylindrical section 17 engages frictionally with the outer surface of the second sun wheel 11 and with the inner surface of the second ring wheel 13. The third cylindrical section 18 engages frictionally with the outer surface of the third sun wheel 12 and with the inner surface of the third ring wheel 14. While only two planetary members are shown, the embodiment comprises at least a third and a fourth planetary member. There is a first bearing 19 between the first sun wheel and the second sun wheel and a second bearing 20 between the first sun wheel and the third sun wheel.

The embodiment can be operated such the first sun wheel is driven. The first ring wheel is fixed against rotation. The second and third sun wheel are allowed to rotate freely. The second and third ring wheel are coupled rotationally and serve as a combined output member. The second and third cylindrical section of the planetary members drive the second and third ring wheels to rotate about the first symmetry axis while their first cylindrical sections roll along the inner surface of the first ring wheel. If operated in this manner, the assembly serves as a two stage speed reducing assembly.

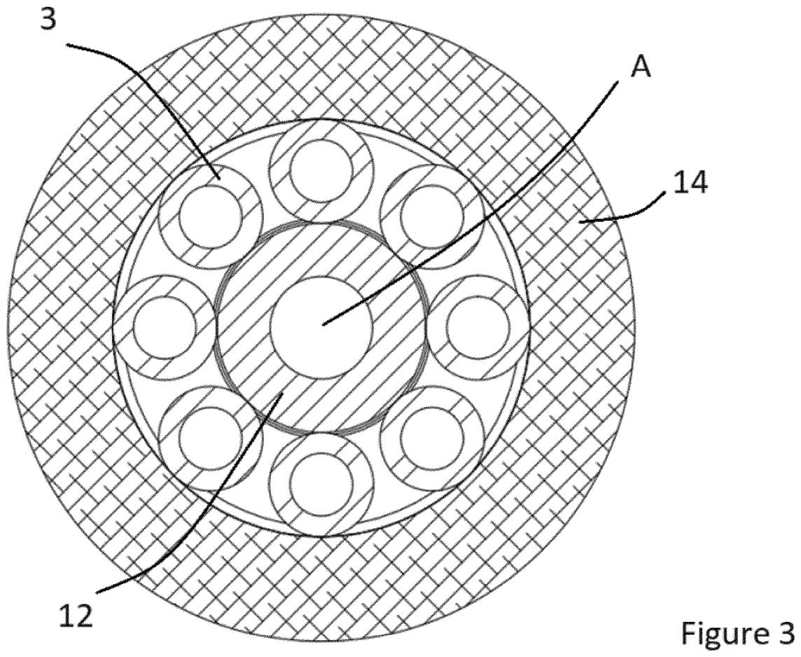

FIG. 3 shows a side view of an exemplary embodiment quite similar to that of FIG. 2. The embodiment comprises ten hollow planetary members 3 which are arranged about the first symmetry axis A. Each of these transfers of fraction of the entire torque between each of the sun wheels and corresponding ring wheels.

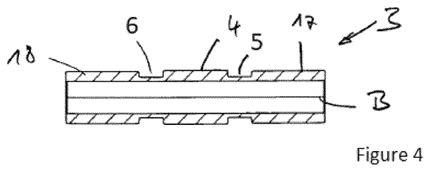

FIG. 4 shows a cross section of one of the planetary members 3 of the embodiments shown by FIGS. 2 and 3. The planetary member comprises (from left to right): the third cylindrical section 18, the second groove 6, the first cylindrical section 4, the first groove 5 and the second cylindrical section 17. The groove side faces may comprise mating shoulders (not shown).

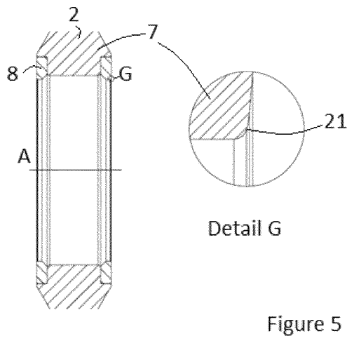

FIG. 5 shows the first ring wheel 2 and two alignment rings 7, 8 of FIGS. 1 to 4. Detail G shows that each of the alignment rings 7, 8 comprises an alignment shoulder 21. These shoulders are arranged at a side face of the respective alignment ring. The alignment shoulders have a radial profile which is preferably straight, convex, concave, or of complex geometry, so as to satisfy the demand for stability implied by the location of the shoulder and the nominal dimensions of the constituent components. The alignment shoulder serves for inducing a stabilizing moment on to the planetary member with a direction and magnitude urging second axis to align more with the first symmetry axis.

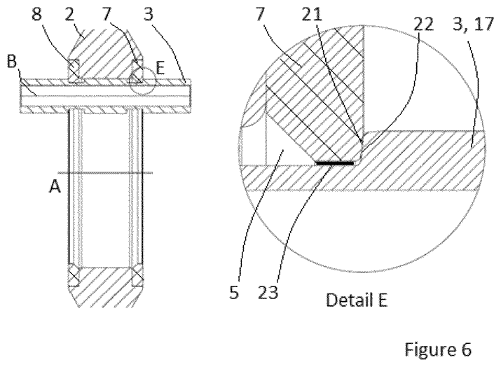

FIG. 6 shows that the alignment rings 7, 8 of FIGS. 1 to 5 engage with respective grooves 5, 6 of one of the planetary members 3. The first cylindrical section 4 of the planetary member engages frictionally with the inner/circumferential face of the first ring wheel 2 but the first sun wheel is not shown. There are mating shoulders 22 on groove side faces of the first and second groove 5, 6 to engage with the respective alignment shoulder 21 of the planetary member. The alignment shoulders and mating shoulders cooperate for inducing a stabilizing moment on to the planetary member with a direction and magnitude urging second axis to align more with the first symmetry axis. Detail E shows that a groove side face of the first groove 5 comprises a mating shoulder 22. Detail E also shows a curved crown 23 protruding from a circumferential face of the first groove 5 towards the circumferential face of first alignment ring 7.

Generally, the skilled person knows curved crowns e.g. from published application EP 3748180 A1 in the context of roller bearings, but not in the context of speed reducing assemblies.

1. Mechanical A mechanical speed reducing assembly comprising:
a first sun wheel,
a first ring wheel arranged concentrically about the first sun wheel, such that the first sun wheel and the first ring wheel share a first symmetry axis,
a hollow first planetary member comprising a first cylindrical section, which first cylindrical section is in frictional engagement with an outer surface of the first sun wheel and with an inner surface of the first ring wheel, the first planetary member being arranged to rotate about a second axis,
wherein the first planetary member comprises a circumferential first groove and a circumferential second groove, which are spaced apart from each other by the first cylindrical section, and
a first alignment ring which is secured to the first sun wheel or to the first ring wheel against motion along the first symmetry axis and which protrudes into the first groove or the second groove.

2. The assembly according to claim 1, wherein the first alignment ring comprises an alignment shoulder, which is arranged to engage with a groove side face of the first groove or of the second groove, which groove side face is generally perpendicular to the second axis.

3. The assembly according to claim 2, wherein the first groove or the second groove comprises a mating shoulder arranged to engage with the alignment shoulder.

4. The assembly according to claim 1, wherein the first ring wheel comprises a first recess extending circumferentially about the first symmetry axis, which first recess is arranged to accept the first alignment ring partially.

5. The assembly according to claim 4, wherein the first ring wheel comprises a second recess extending circumferentially about the first symmetry axis and spaced apart from the first recess along the first symmetry axis, which second recess is arranged to accept the first alignment ring partially.

6. The assembly according to claim 1, wherein the first sun wheel comprises a first recess extending circumferentially about the first symmetry axis, which first recess is arranged to accept the first alignment ring partially.

7. The assembly according to claim 6, wherein the first sun wheel comprises a second recess extending circumferentially about the first symmetry axis and spaced apart from the first recess along the first symmetry axis, which second recess is arranged to accept the first alignment ring partially.

8. The assembly according to claim 7, further comprising a second alignment ring similar to the first alignment ring, which second alignment ring is to be arranged partially in the second recess.

9. The assembly according to claim 8, wherein the first alignment ring engages with the first groove or the second alignment ring engages with the second groove.

10. The assembly according to claim 1, wherein the first alignment ring, the second alignment ring, the first recess or the second recess comprises a curved crown.

11. The assembly according to claim 1, further comprising a second planetary member and a third planetary member similar to the first planetary member, which planetary members are arranged about the first symmetry axis, each of which is in frictional engagement with the outer surface of the first sun wheel and with the inner surface of the first ring wheel.

12. The assembly according to claim 1, wherein at least the first planetary member comprises a second cylindrical section similar to the first cylindrical section, wherein the first groove is arranged between the second cylindrical section and the first cylindrical section.

13. The assembly according to claim 11, further comprising a second sun wheel and a second ring wheel arranged concentrically about the second sun wheel, wherein the second sun wheel and the second ring wheel share the first symmetry axis, wherein the second cylindrical section is in frictional engagement with an outer surface of the second sun wheel and with an inner surface of the second ring wheel.

14. The assembly according to claim 13, further comprising a bearing arranged about the first axis of symmetry, wherein the bearing engages with a sun wheel side face of the first sun wheel and a sun wheel side face of the second sun wheel, which sun wheel side faces are perpendicular to the first symmetry axis.

15. The assembly according to claim 13, further comprising a third ring wheel, wherein the first ring wheel is arranged between the second ring wheel and the third ring wheel, wherein at least the first planetary member, particular a third cylindrical section, is in frictional engagement with an inner surface of the third ring wheel.

16. The assembly according to claim 15, wherein the second and third ring wheel are coupled rotationally.

17. A method of manufacturing a mechanical speed reducing assembly including a first sun wheel, a first ring wheel having a first recess and a second recess, a hollow first planetary member comprising a first cylindrical section in frictional engagement with an outer surface of the first sun wheel and with an inner surface of the first ring wheel, the first planetary member being arranged to rotate about a second axis, wherein the first planetary member comprises a circumferential first groove and a circumferential second groove the method, comprising
inserting a first alignment ring into the first recess of the first ring wheel;
inserting the first alignment ring into the first groove of the first planetary member; and
arranging the first sun wheel relative to the first ring wheel such that these are arranged concentrically and share a first symmetry axis.

18. The method of claim 17, further comprising inserting a second alignment ring into the second groove of the first planetary member.

19. The method of claim 18, further comprising inserting the second alignment ring into the second recess of the first ring wheel.

20. The method of claim 19, further comprising forming a curved crown using the first alignment ring, the second alignment ring, the first recess, and the second recess.
